(19) United States
(12) Patent Application Publication
(10) Pub. No.: US 2004/0200199 A1
(43) Pub. Date: Oct. 14, 2004

(54) Automatic hedge-trimming system

(76) Inventor: Andre Colens, Rixensart (BE)

Correspondence Address: Robert M Gamson, Armstrong Kratz Quintos Hanson & Brooks, Suite 220, 502 Washington Avenue, Towson, MD, 21204, US

(21) Appl. No.: 10/479,377

(22) PCT Filed: May 28, 2002
(86) PCT No.: PCT/BE02/00087

(30) Foreign Application Priority Data
May 28, 2001 (BE) 010362

(51) Int. Cl. A01D 75/28

(52) U.S. Cl. 56/10.2 R

(57) ABSTRACT

The invention concerns a device for the upkeep of a hedge (10) comprising an element adapted to move in reciprocating motion parallel above and/or beside the hedge (10). The displacement is performed repeatedly and automatically so as to prevent the hedge from growing beyond a predetermined limit by the trajectory of the mobile element. The mobile element is shaped like a gantry and moves along one or several aerial or ground rails (4). The ridges of the gantry are fitted with a cutting edge or with an abrasive element (6). The mobile element is driven by a roller (3) and is mounted on an electric gear motor (1).

This invention concerns a process and a device for the upkeep of a shrub, a group of shrubs and more particularly a hedge, or more generally any volume or surface of plants that could be the object of regular cutting or trimming.

More specifically, the maintenance of a hedge presents four main problems:

1. Trimming a hedge is a fastidious, repetitive job

2. A good result requires great care and dexterity by the operator to avoid unattractive ripples.

3. Trimming causes a lot of waste that is often hard to eliminate.

4. The trimming operation is dangerous—statistically it represents one of the highest rates of household accidents.

Automatic upkeep of a hedge has been the subject of several patent documents proposing devices to aid trimming by otherwise classical means, i.e. periodic maintenance requiring the intervention of a person. These solutions have not proved satisfactory.

The purpose of this invention is to provide a solution to the various problems mentioned above.

Under a first mode for carrying out the invention, a trimming or upkeep device for a hedge is disclosed comprising a gantry on a rail placed at the top of the hedge over the entire length.

The gantry moves regularly on the rail, parallel to the hedge. The shape of the gantry, more specifically its profile in the transverse plane, defines the profile to be given to the hedge by the transversal cut.

The upper and/or transversal edges of the gantry are preferably equipped with a cutting or abrasive device.

The regular passage of the gantry destroys the ends of shoots facing outward and therefore prevents the hedge from growing outward.

By a simple mechanical effect, the regular movement of the gantry along the hedge prevents outer shoots from growing, as it is the case along a path through thick vegetation; such path being maintained by the regular passage of one or several animals.

Other devices could be mounted on the gantry to produce the same result, that being a trimming, abrasive effect or inhibition of growth of shoots (hot wire, chemical product, electric discharge . . . ). A wire or a small-toothed chain, that can move like a traditional chainsaw, continuously or by impulses, can also be envisaged on adapting the gantry for the purpose.

In a variant, the edges of the gantry can carry blades able to act with a shearing effect, which entails a mechanism for a reciprocating movement, continuously or by impulses, against a bedknife. The system can be made harmless insofar as the trim is meant to act on very small shoots. The exposed parts of the blades or the teeth can be quite small dimension.

Advantageously, the shearing effect can be triggered only when the system feels resistance to forward movement of the gantry, due to the presence of a shoot or a twig. This device can operate electromechanically or by including an appropriate electronic circuit.

In the first case, as an example, when the device feels resistance to a forward movement due to a relatively resistant shoot or twig, energy can accumulate, for example in a spring, which, beyond a certain pressure, unwinds and triggers a sharp movement of blade against a bedknife.

In the case of electronic activation, when resistance is felt by the device, a capacitor can charge, and beyond a certain, predefined point, discharge, providing the energy required for the shearing movement. In this case, the cycle can be advantageously managed by microprocessor that could take account of other parameters.

According to a mode for carrying out the invention, the gantry is pulled by a roller mounted on a low-power (a few watts) electric gear motor. A small solar panel mounted on the mobile gantry can power the motor.

Alternatively, the power supply for the motor can come from a small battery integrated in the gantry, for example 6V-0.5 Ah; that can automatically be recharged by contact with a charger fixed at the end of the rail, the charger itself could be powered by photovoltaic cells.

In another mode for carrying out the invention, if the environment is suitable, the source of energy is simply traditional electric power supply on the network.

In another mode for carrying out the invention, the operation of the device is very simple. The gantry equipped with a solar panel moves slowly from one end of the rail to the other. When it gets to the end, an inverter changes the direction of the rotation of the driving motor and the gantry moves back in the other direction. The gantry moves continually when sufficient light falls on the solar panel.

In the case of a battery system, when the gantry gets to the end of the rail on the side where the charger is mounted, a lag could enable the battery to recharge before the gantry continues in the other direction.

A fixed motor placed at the end of the hedge, for example, can also be used for as a driving motor pulling in one direction and then in the other on a suitable cable attached to the gantry.

The device described solves the four problems identified below:

1. It eliminates the need to trim the hedge regularly.

2. It gives the hedge a perfectly regular shape, determined longitudinally by the fixed rail and transversely by the mobile gantry.

3. The automatic system does not create waste.

4. The device is extremely safe, using low power levels and no dangerous components.

The speed of movement can vary for example with the kind of plant volume to be controlled; the reciprocating movement could occur, for example, at the intervals varying from a few times a day to a few dozen times a day.

In another mode for carrying out the invention, the rail is installed above the entire length of the hedge that can include curves and corners. The rail can be maintained by stakes placed at regular intervals.

Alternatively, again in a mode for carrying out the invention, the mobile element serving as the gantry can move on rails set on the ground, on one or both sides of the hedge—the mobile element prevents the growth of the hedge on one or two sides depending on its configuration.

Motorization can therefore be provided on the ground, whereas the device carrying the profile moves along the rail. The variants for the power supply described for an aerial rail are easily transposable to a rail on the ground.

It should be noted that in a mode that currently is less preferable, the gantry can also move along one or several tight wires, the technique for setting it in movement could be similar to the technology of a cable car (bearing wire, pulling wire).

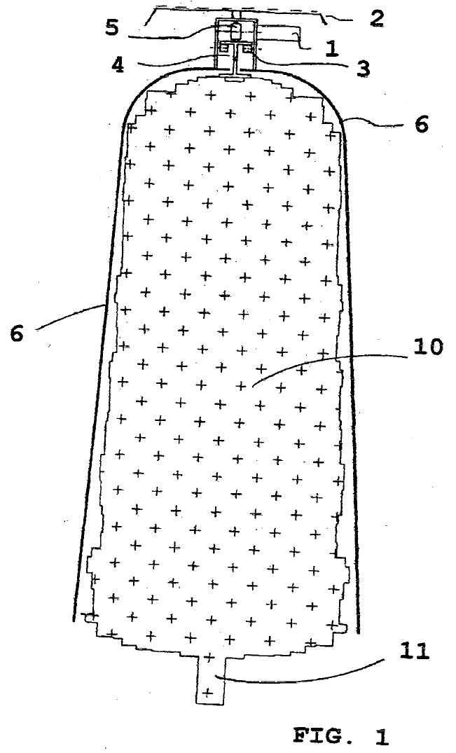

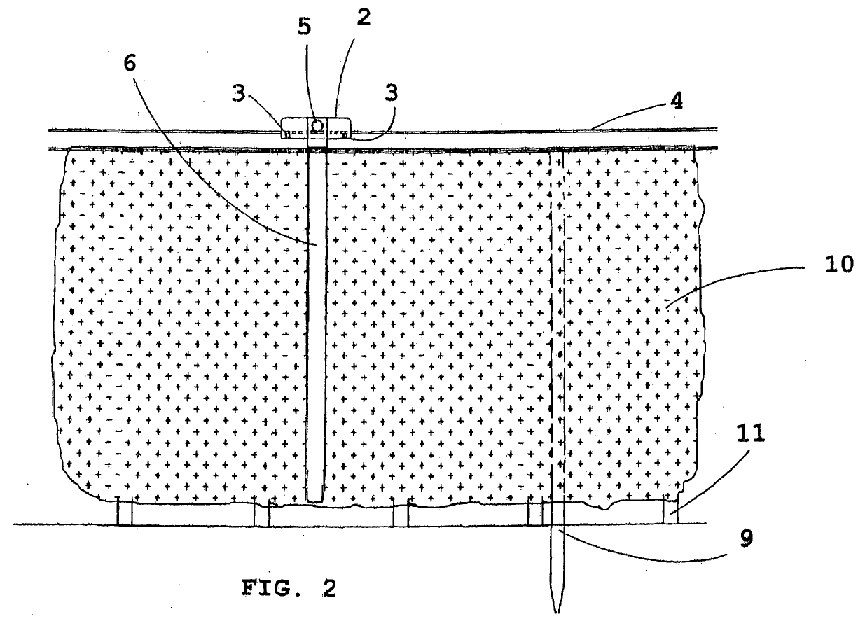

The invention can be understood better by looking at FIG. 1 and FIG. 2 that represent a device for carrying out the invention in a transverse section and a side view.

FIG. 1 shows the hedge 10 with a fixed overhead parallel rail 4 placed at the middle of the top of the hedge. An electric motor 1 pulls a wheel or roller 5 and causes movement of the carriage carrying an abrasive profile 6 extending on either side along the hedge. Note the presence of rollers 3 and of a solar battery panel 2 and/or a rechargeable battery (not illustrated) to power the motor.

FIG. 2 shows a stake 9 supporting the rail, and the trunks of the shrubs 11 forming the hedge, in addition to the elements illustrated in FIG. 1.

It is understood that the invention can apply to plant volumes other than hedges. A shrub or group of shrubs can also be kept up by arranging for the displacement of an element having a profile corresponding to the desired shape of the plant volume.

In a mode for carrying out the invention, this displacement can occur around an axis, fixed or no, mounted approximately in the middle of an isolated shrub that carries the rotating profile element, which may be cutting, or abrasive. Like for a gantry, the motor, mounted at the base or the summit of the axis, can be powered by the electric network, by batteries and/or by solar cell.

It is understood that the installation can be presented and marketed in the form of kits ready to be mounted. The modular system including, for example, straight and/or curved rails, stakes at varying or adjustable heights, an electric power supply system and a motorized gantry whose profile is adaptable to the plant volume to be kept up. The rails can be extended by a fastening system in a known way. The product is adaptable to any plant configurations.

It is also understood that there can be several gantries on the same rail, independent or attached together.

Under another variant, the mobile element preventing growth is a grille or mesh. The growth of the plant volume is prevented by a back-and-forth movement, restricted or no, of the grille or mesh enveloping or partially limiting the plant volume. This movement can be continuous or no. In the latter case, impulses are produced as indicated above, but they cause a movement of the grille. Preferably, the grille is made of abrasive or cutting parts. The grille can be single or double, in the latter case holding a second independent grille component, fixed or not. An shearing action can then be advantageously produced, for example, between a fixed grille acting as a bedknife and a cutting grille moving back and forth, preferably under the impetus of automatic impulses.

1. Device for the upkeep of a hedge containing a mobile part that can move in a parallel reciprocating motion above and/or alongside a hedge, this motion being made repetitively and automatically so that the growth of the hedge beyond a limit determined by the path of the mobile part is prevented.

2. Device according to claim 1 in which the mobile part takes the form of a gantry.

3. Device according to claim 1 in which the mobile part moves along at least one rail.

4. Device according to claim 1 in which the at least one rail is placed above the hedge.

5. Device according to claim 1 in which the at least one rail is supported by stakes.

6. Device according to claim 1 wherein the at least one rail is placed on the ground along or around the hedge.

7. Device according to claim 2 in which the the gantry has edges, the edges are cutting edges or equipped with an abrasive element.

8. Device according to claim 3 wherein the mobile part moves by means of a roller and is mounted on an electric gear motor.

9. Device according to claim 1 wherein the mobile part has an electric gear motor which is powered by a rechargeable battery.

10. Device according to claim 9 in which the battery recharges automatically by contact with a fixed charger at one end of the at least one rail.

11. Device according to claim 2 wherein there is provided an electric gear motor is powered by a solar battery fixed to the mobile gantry.

12. Process for the upkeep of a hedge using the device under claim 1.

13. Process for the upkeep of a plant surface or volume consisting of displacing an element, during the growth season, periodically and continually or essentially continually, above or around that plant surface or volume to prevent the growth of shoots beyond a limit predetermined by the shape of that element.

14. Process according to claim 13 in which the element includes a cutting or abrasive edge, fixed or moving with regard to that element.

15. Process under claim 13 in which the displacement consists of a rotation around an axis placed in the plant volume, possibly in first direction and then a second direction.

16. Kit including the parts of the device under claim 3.
